(19) United States
(12) Patent Application Publication
(10) Pub. No.: US 2009/0046644 A1
(43) Pub. Date: Feb. 19, 2009

(54) SERVICE SET MANAGER FOR AD HOC MOBILE SERVICE PROVIDER

(75) Inventors: Dilip Krishnaswamy, San Diego, CA (US); Atul Suri, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/188,979

(22) Filed: Aug. 8, 2008

Related U.S. Application Data
(60) Provisional application No. 60/956,658, filed on Aug. 17, 2007.
(60) Provisional application No. 60/980,547, filed on Oct. 17, 2007.

(51) Int. Cl. H04Q 7/00; H04M 1/66; H04Q 7/20

(52) U.S. Cl. 370/329; 380/247; 455/452.1; 370/465

(57) ABSTRACT

An ad hoc mobile service provider for a wireless network includes a processing system configured to support a public service set, comprising the ad hoc mobile service provider and one or more mobile clients, and a private service set, comprising the ad hoc mobile service provider and one or more authenticated mobile clients. The processing system is further configured to authenticate a mobile client with a server, the mobile client being associated with the public service set, and transfer an authenticated mobile client from the public service set to the private service set.

### CROSS-REFERENCE TO RELATED APPLICATIONS

The present application for patent claims priority under 35 U.S.C. § 119 to Provisional Application No. 60/956,658 entitled, “Method for a Heterogeneous Wireless Ad Hoc Mobile Service Provider,” filed Aug. 17, 2007, and to Provisional Application No. 60/980,547 entitled, “Service Set Manager for Ad Hoc Mobile Service Provider,” filed Oct. 17, 2007, both of which are hereby incorporated by reference.

### BACKGROUND

1. Field

The present disclosure relates generally to telecommunications, and more specifically to the management of service sets associated with an ad hoc mobile service provider for a wireless network.

2. Background

Wireless telecommunication systems are widely deployed to provide various services to consumers, such as telephony, data, video, audio, messaging, broadcasts, etc. These systems continue to evolve as market forces drive wireless telecommunications to new heights. Today, wireless networks are providing broadband Internet access to mobile subscribers over a regional, a nationwide, or even a global region. Such networks are sometimes referred as Wireless Wide Area Networks (WWANs). WWAN operators generally offer wireless access plans to their subscribers such as subscription plans at a monthly fixed rate.

Accessing WWANs from all mobile devices may not be possible. Some mobile devices may not have a WWAN radio. Other mobile devices with a WWAN radio may not have a subscription plan enabled. Ad hoc networking allows mobile devices to dynamically connect over wireless interfaces using protocols such as WLAN, Bluetooth, UWB or other protocols. There is a need in the art for a methodology to allow a user of a mobile device without WWAN access to dynamically subscribe to wireless access service provided by a user with a WWAN-capable mobile device using wireless ad hoc networking between the mobile devices belong to the two users.

### SUMMARY

In one aspect of the disclosure, an ad hoc mobile service provider for a wireless network includes a processing system configured to support a public service set, comprising the ad hoc mobile service provider and one or more mobile clients, and a private service set, comprising the ad hoc mobile service provider and one or more authenticated mobile clients. The processing system is further configured to authenticate a mobile client with a server, the mobile client being associated with the public service set, and transfer an authenticated mobile client from the public service set to the private service set.

In another aspect of the disclosure, an ad hoc mobile service provider for a wireless network includes means for supporting a public service set, comprising the ad hoc mobile service provider and one or more mobile clients, and means for supporting a private service set, comprising the ad hoc mobile service provider and one or more authenticated mobile clients. The ad hoc mobile service provider further includes means for authenticating a mobile client with a server, the mobile client being associated with the public service set, and means for transferring an authenticated mobile client from the public service set to the private service set.

In a further aspect of the disclosure, a method for managing an ad hoc mobile service provider for a wireless network includes authenticating a mobile client with a server, wherein the mobile client is associated with a public service set comprising the ad hoc mobile service provider and the mobile client, and transferring the authenticated mobile client from the public service set to a private service set comprising the ad hoc mobile service provider and one or more authenticated mobile clients.

In yet a further aspect of the disclosure, a machine-readable medium comprising instructions executable by a processing system in an ad hoc mobile service provider for a wireless network is provided. The instructions include code for authenticating a mobile client with a server, wherein the mobile client is associated with a public service set comprising the ad hoc mobile service provider and the mobile client, and transferring the authenticated mobile client from the public service set to a private service set comprising the ad hoc mobile service provider and one or more authenticated mobile clients.

It is understood that other embodiments of the present invention will become readily apparent to those skilled in the art from the following detailed description, wherein various embodiments of the invention are shown and described by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

FIG. 1 is a simplified block diagram illustrating an example of a telecommunications system.

FIG. 2 is a simplified block diagram illustrating an example of the functionality of an ad hoc mobile service provider.

FIG. 3 is a simplified block diagram illustrating an example of a hardware configuration for an ad hoc mobile service provider.

FIG. 4 is a flowchart illustrating an exemplary method for managing an ad hoc mobile service provider.

FIG. 5 is a simplified block diagram illustrating an example of a hardware configuration for a processing system in an ad hoc mobile service provider.

### DETAILED DESCRIPTION

The detailed description set forth below in connection with the appended drawings is intended as a description of various configurations of the present invention and is not intended to represent the only configurations in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention.

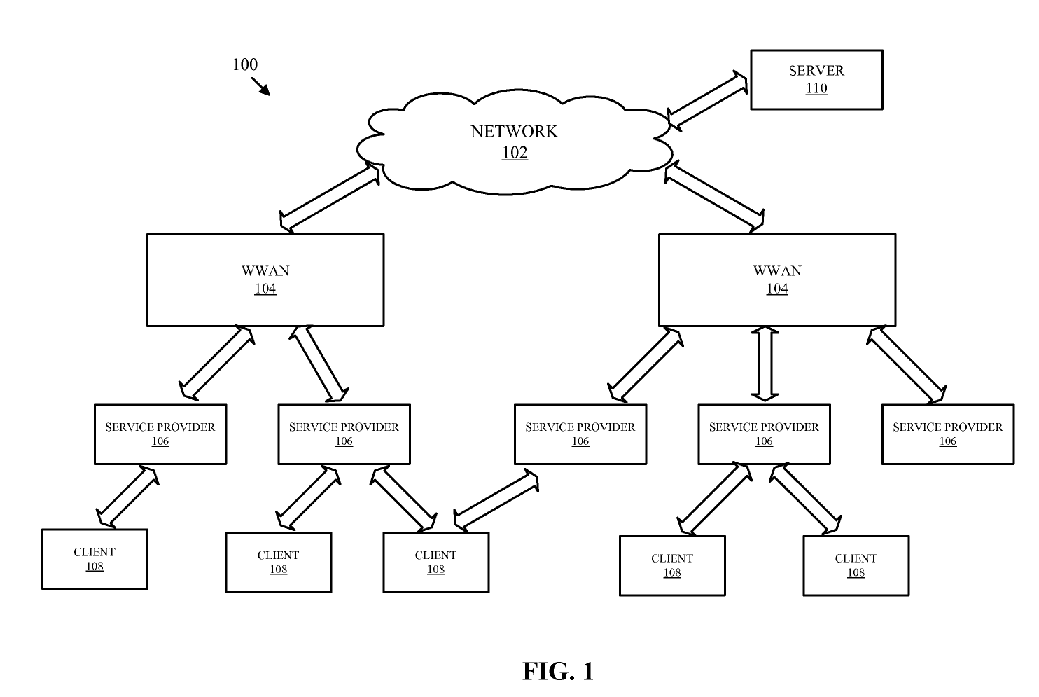

FIG. 1 is a simplified block diagram illustrating an example of a telecommunications system. The telecommunications system 100 is shown with multiple WWANs 104 that provide broadband access to a network 102 for mobile subscribers. The network 102 may be a packet-based network such as the Internet or some other suitable network. For clarity of presentation, two WWANs 104 are shown with a backhaul connection to the network 102. However, the number of WWANs providing broadband access to network 102 is not limited to two WWANs. Each WWAN 104 may be implemented with multiple fixed-site base stations (not shown) dispersed throughout a geographic region. The geographic region may be generally subdivided into smaller regions known as cells. Each base station may be configured to serve all mobile subscribers within its respective cell. A base station controller (not shown) may be used to manage and coordinate the base stations in the WWAN 104 and support the backhaul connection to the network 102.

Each WWAN 104 may use one of many different wireless access protocols to support radio communications with mobile subscribers. By way of example, one WWAN 104 may support Evolution-Data Optimized (EV-DO), while the other WWAN 104 may support Ultra Mobile Broadband (UMB). EV-DO and UMB are air interface standards promulgated by the 3rd Generation Partnership Project 2 (3GPP2) as part of the CDMA2000 family of standards and employ multiple access techniques such as Code Division Multiple Access (CDMA) to provide broadband Internet access to mobile subscribers. Alternatively, one of the WWANs 104 may support Long Term Evolution (LTE), which is a project within the 3GPP2 to improve the Universal Mobile Telecommunications System (UMTS) mobile phone standard based primarily on a Wideband CDMA (W-CDMA) air interface. One of the WWANs 104 may also support the WiMAX standard being developed by the WiMAX forum. The actual wireless access protocol employed by a WWAN for any particular telecommunications system will depend on the specific application and the overall design constraints imposed on the system. The various techniques presented throughout this disclosure are equally applicable to any combination of heterogeneous or homogeneous WWANs regardless of the wireless access protocols utilized.

Each WWAN 104 has a number of mobile subscribers. Each subscriber may have a mobile node capable of accessing the network 102 directly through the WWAN 104. The mobile nodes access the WWAN 104 shown in the telecommunications system in FIG. 1 using an EV-DO, UMB or LTE wireless access protocol; however, in actual implementations, these mobile nodes may be configured to support any wireless access protocol.

One or more of the mobile nodes may be configured to create in its vicinity an ad hoc network based on the same or a different wireless access protocol used to access the WWAN 104. By way of example, a mobile node may support a UMB wireless access protocol with a WWAN, while providing an IEEE 802.11 access point for other mobile nodes that cannot directly access a WWAN. IEEE 802.11 denotes a set of Wireless Local Access Network (WLAN) standards developed by the IEEE 802.11 committee for short-range communications (e.g., tens of meters to a few hundred meters). Although IEEE 802.11 is a common WLAN wireless access protocol, other suitable protocols may be used.

A mobile node that may be used to provide an access point for another mobile node will be referred to herein as a “ad hoc service provider” and is represented in FIG. 1 as a service provider 106. A mobile node that may use an access point of an ad hoc service provider 106 will be referred to herein as a “mobile client” and is represented in FIG. 1 as a client 108. A mobile node, whether an ad hoc service provider 106 or a client 108, may be a laptop computer, a mobile telephone, a personal digital assistant (PDA), a mobile digital audio player, a mobile game console, a digital camera, a digital camcorder, a mobile audio device, a mobile video device, a mobile multimedia device, or any other device capable of supporting at least one wireless access protocol.

The ad hoc service provider 106 may extend its wireless broadband network access service to mobile clients 108 that would otherwise not have access to the network 102. A server 110 may be used as an “exchange” to enable mobile clients 108 to purchase unused bandwidth from ad hoc service providers 106 to access, for example, the network 102 across WWANs 104.

An ad hoc service provider 106, a server 110, and one or more mobile clients 108 may establish a network that is an ad hoc heterogeneous wireless network. By way of example, a heterogeneous wireless network may include at least two types of wireless networks (e.g., a WWAN and a WLAN). By way of example, an ad hoc network may be a network whose specific configuration may change from time to time or from the formation of one network to the next. The network configuration is not pre-planned prior to establishing the network. Examples of configurations for an ad hoc network may include a configuration as to which members are to be in the network (e.g., which ad hoc service provider, which server, and/or which mobile client(s) are to be included in a network), a configuration as to the geographic locations of an ad hoc service provider and mobile client(s), and a configuration as to when and how long a network is to be established.

For illustrative purposes only, exemplary scenarios of ad hoc networks are described below. Scenario 1: While a mobile subscriber is at an airport on Tuesday 8 am, he may turn on his mobile node (e.g., a laptop computer or a mobile telephone), use it as an ad hoc service provider while he is waiting for his flight, and establish an ad hoc network for thirty minutes. The ad hoc network may include one or more mobile clients (e.g., other laptop computers or mobile telephones) in the vicinity. Scenario 2: On Wednesday 5 pm, while the mobile subscriber is at a hotel, he may use the same mobile node as an ad hoc service provider to form another ad hoc network for four hours, providing its service to the same mobile clients, different mobile clients, or a combination of both. Scenario 3: On Wednesday 5 pm, a different ad hoc service provider may form an ad hoc network at the airport where the first ad hoc service provider was the day before. Because the service providers and clients are mobile, an ad hoc network can be a “mobile” network.

The server 110 may be a centralized server or a distributed server. The centralized server may be a dedicated server or integrated into another entity such as a desktop or laptop computer, or a mainframe. The distributed server may be distributed across multiple servers and/or one or more other entities such as laptop or desktop computers, or mainframes. In at least one configuration, the server 110 may be integrated, either in whole or in part, into one or more ad hoc service providers.

In one configuration of a telecommunications system 100, the server 110 charges the mobile clients 108 based on usage. For the occasional user of mobile Internet services, this may be an attractive alternative to the monthly fixed rate wireless access plans. The revenue generated from the usage charges may be allocated to the various entities in the telecommunications system 100 in a way that tends to perpetuate the vitality of the exchange. By way of example, a portion of the revenue may be distributed to the ad hoc service providers, thus providing a financial incentive for mobile subscribers to become ad hoc service providers. Another portion of the revenue may be distributed to the WWAN operators to compensate them for the bandwidth that would otherwise go unutilized. Another portion of the revenue may be distributed to the manufacturers of the mobile nodes. The remainder of the revenue could be kept by the server operator that provides the exchange. The server 110, which may be a centralized server as shown or a distributed server including multiple servers, may be used to determine how to allocate revenue generated from the mobile clients 108 to the various entities in the telecommunications system 100.

The server 110 may be implemented as a trusted server. It can therefore be authenticated, for example, using a Public Key Infrastructure (PKI) certificate in a Transport Layer Security (TLS) session between the server 110 and an ad hoc service provider 106, or between the server 110 and a mobile client 108. Alternatively, the server 110 may be authenticated using self-signed certificates or by some other suitable means.

Regardless of the manner in which the server 110 is authenticated, a secure session channel may be established between the server 110 and an ad hoc service provider 106, or between the server 110 and a mobile client 108, during registration. In one configuration of a telecommunications system 100, a mobile client 108 may register with the server 110 to set up a user name and password with payment information. An ad hoc service provider 106 may register with the server 110 to notify its desire to provide a wireless access point to the network 102 (e.g., an Internet access point) to mobile clients 108.

The server 110 may also be used to provide admission control. Admission control is the process whereby the server 110 determines whether to allow an ad hoc service provider 106 to provide service within a geographic location. The server 110 may limit the number of ad hoc service providers 106 at a given location if it determines that additional ad hoc service providers 106 will adversely affect performance in the WWAN. Additional constraints may be imposed by the WWAN operators that may not want its mobile subscribers to provide service in a given geographic location depending on various network constraints.

The server 110 may also be used to manage dynamic sessions that are established between the ad hoc service providers 106 and the mobile clients 108. In one configuration of the telecommunications system 100, Extensible Authentication Protocol-Tunneled Transport Layer Security (EAP-TTLS) may be used for Authentication, Authorization and Accounting (AAA) and secure session establishment for a connection initiated by an ad hoc service provider 106 with the server 110 when the ad hoc service provider 106 is mobile and desires to provide service. EAP-TTLS may also be used for a session initiation request by a mobile client 108. In the latter case, the mobile client 108 is the supplicant, the ad hoc service provider 106 is the authenticator, and the server 110 is the authentication server. The ad hoc service provider 106 sends the mobile client's credentials to the server 110 for EAP-AAA authentication. The EAP-TTLS authentication response from the server 110 is then used to generate a Master shared key. Subsequently, a link encryption key may be established between the ad hoc service provider 106 and the mobile client 108.

Additional security may be achieved with a Secure Sockets Layer Virtual Private Network (SSL VPN) tunnel between a mobile client 108 and the server 110. The SSL VPN tunnel is used to encrypt traffic routed through an ad hoc service provider 106 to provide increased privacy for a mobile client 108. Alternatively, the tunnel may be an IPsec tunnel or may be implemented using some other suitable tunneling protocol.

Once the tunnel is established between the server 110 and the mobile client 108, various services may be provided. By way of example, the server 110 may support audio or video services to the mobile client 108. The server 110 may also support advertising services to the mobile client 108. Other functions of the server 110 include providing routing to and from the network for mobile client 108 content as well as providing network address translation to and from the network for mobile client 108.

The server 110 may also provide support for a handoff of a mobile client 108 from one ad hoc service provider 106 to another based on any number of factors. These factors may include, by way of example, the quality of service (QoS) required by each mobile client 108, the duration of the session required by each mobile client 108, and the loading, link conditions, and energy level (e.g., battery life) at the ad hoc service provider 106.

The server 110 also may be used to store a goodness metric for each ad hoc service provider 106. The goodness metric reflects the level of service an ad hoc service provider 106 has provided during previous access sessions with mobile clients 108. The server 110 may monitor each session between an ad hoc service provider 106 and a mobile client 108 and update the goodness metric associated with the ad hoc service provider 106 based on one or more factors. The factors may include, but are not limited to, the duration of the access session and the average bandwidth of access to the WWAN 104 provided to the mobile client 108. Monitored factors may be assigned a value from a range of values for each session. The goodness metric for the session may be the sum or average of these values. As an ad hoc service provider 108 provides more access sessions to mobile clients 108, the goodness metric associated with the ad hoc service provider may be continually updated by averaging the goodness metrics from prior access sessions. This average may be a straight average or it may be weighted to favor more recent access sessions.

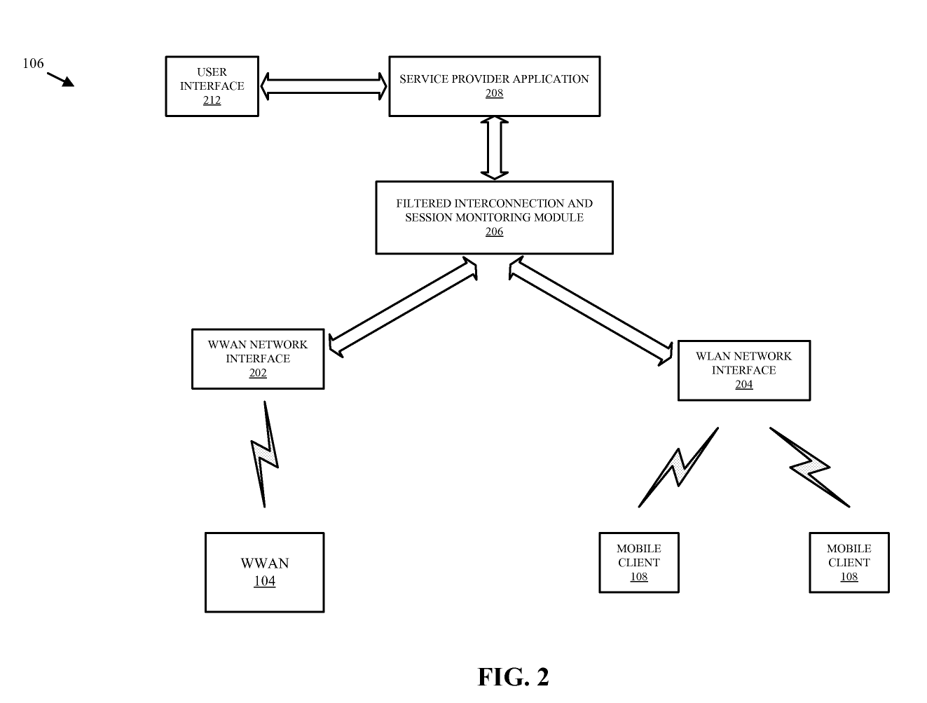

FIG. 2 is a simplified block diagram illustrating an example of the functionality of an ad hoc service provider 106. The ad hoc service provider 106 has the ability to bridge wireless links over homogeneous or heterogeneous wireless access protocols. This may be achieved with a WWAN network interface 202 that supports a wireless access protocol for a WWAN to the network 102, and a WLAN network interface 204 that provides a wireless access point for mobile clients 108. By way of example, the WWAN network interface 202 may include a transceiver function that supports EV-DO for Internet access through a WWAN 104, and the WLAN network interface 204 may include a transceiver function that provides an 802.11 access point for mobile clients 108. Each network interface 202, 204 may be configured to implement the physical layer by demodulating wireless signals and performing other radio frequency (RF) front end processing. Each network interface 202, 204 may also be configured to implement the data link layer by managing the transfer of data across the physical layer.

The ad hoc service provider 106 is shown with a filtered interconnection and session monitoring module 206. The module 206 provides filtered processing of content from mobile clients 108 so that the interconnection between the ad hoc wireless link and the WWAN network interface 202 is provided only to mobile clients 108 authenticated by the server. The module 206 is also responsible for monitoring the sessions between the server and the authenticated mobile clients 108. The module 206 also maintains tunneled connectivity between the server and the authenticated mobile clients 108.

The ad hoc service provider 106 also includes a service provider application 208 that (1) enables the module 206 to provide ad hoc services to mobile clients 108, and (2) supports WWAN or Internet access to a mobile subscriber or user of the ad hoc service provider 106. The latter function is supported by a user interface 212 that communicates with the WWAN network interface 202 through the module 206 under control of the service provider application 208. The user interface 212 may include a keypad, display, speaker, microphone, joystick, and/or any other combination user interface devices that enable a mobile subscriber or user to access the WWAN 104 or the network 102 (see FIG. 1).

As discussed above, the service provider application 208 also enables the module 206 to provide ad hoc services to mobile clients 108. The service provider application 208 maintains a session with the server 110 to exchange custom messages with the server. In addition, the service provider application 208 also maintains a separate session with each mobile client 108 for exchanging custom messages between the service provider application 208 and the mobile client 108. The service provider application 208 provides information on authenticated and permitted clients to the filtered interconnection and session monitoring module 206.

The filtered interconnection and session monitoring module 206 allows content flow for only authenticated and permitted mobile clients 108. The filtered interconnection and session monitoring module 206 also optionally monitors information regarding content flow related to mobile clients 108 such as the amount of content outbound from the mobile clients and inbound to the mobile clients, and regarding WWAN and WLAN network resource utilization and available bandwidths on the wireless channels. The filtered interconnection and session monitoring module 206 can additionally and optionally provide such information to the service provider application 208. The service provider application 208 can optionally act on such information and take appropriate actions such as determining whether to continue maintaining connectivity with the mobile clients 108 and with the server, or whether to continue to provide service. It should be noted that the functions described in connection with module 206 and service provider application 208 can be implemented in any given platform in one or multiple sets of modules that coordinate to provide such functionality at the ad hoc service provider 106.

When the ad hoc service provider 106 decides to provide the ad hoc services, the service provider application 208 sends a request to the server 110 for approval. The service provider application 208 requests authentication by the server 110 and approval from the server 110 to provide service to one or more mobile clients 108. The server 110 may authenticate the ad hoc service provider 106 and then determine whether it will grant the ad hoc service provider's request. As discussed earlier, the request may be denied if the number of ad hoc service providers in the same geographic location is too great or if the WWAN operator has imposed certain constraints on the ad hoc service provider 106.

Once the ad hoc service provider 106 is authenticated, the service provider application 208 may advertise service information for the ad hoc service provider. The service provider application 208 may also prompt changes to the advertised service information as conditions change. Interested mobile clients 108 may associate with an Service Set Identifier (SSID) to access the ad hoc service provider 106. The service provider application 208 may then route authentication messages between the mobile clients 108 with the server 110 and configure the filtered interconnection and session monitoring module 206 to connect the mobile clients 108 to the server once authenticated. During the authentication of a mobile client 108, the service provider application 208 may use an unsecured wireless link.

The service provider application 208 may manage the mobile client 108 generally, and the session specifically, through the user interface 212. Alternatively, the service provider application 208 may support a seamless operation mode with processing resources being dedicated to servicing mobile clients 108. In this way, the mobile client 108 is managed in a way that is transparent to the mobile subscriber. The seamless operation mode may be desired where the mobile subscriber does not want to be managing mobile clients 108, but would like to continue generating revenue by sharing bandwidth with mobile clients 108.

Although not shown, the ad hoc service provider 106 may also include a server application. The server application may be used to enable the ad hoc service provider 106 to function as a server to authenticate mobile clients 108.

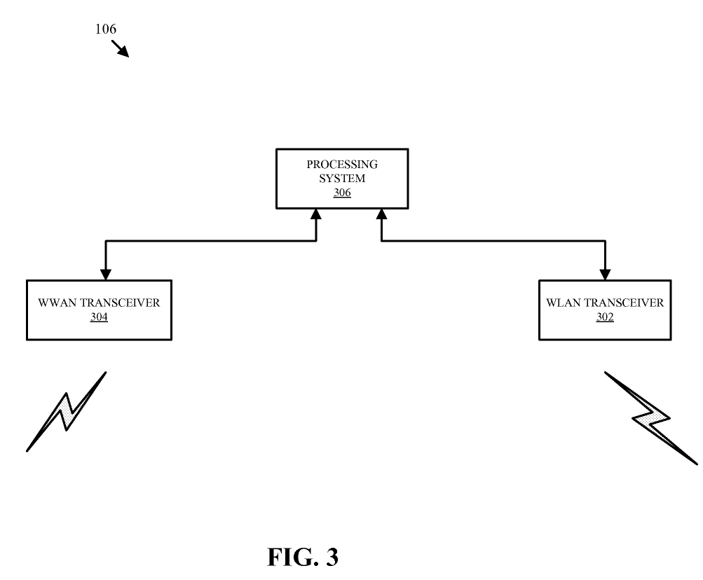

FIG. 3 is a simplified block diagram illustrating an example of a hardware configuration for an ad hoc service provider. The ad hoc service provider 106 is shown with a WLAN transceiver 302, a WWAN transceiver 304, and a processing system 306. By way of example, the WLAN transceiver 302 may be used to implement the analog portion of the physical layer for the WLAN network interface 202 (see FIG. 2), and the WWAN transceiver 304 may be used to implement the analog portion of the physical layer for the WWAN network interface 204 (see FIG. 2).

The processing system 306 may be used to implement the digital processing portion of the physical layer, as well as the link layer, for both the WLAN and the WWAN network adaptors 202 and 204 (see FIG. 2). The processing system 306 may also be used to implement the filtered interconnection and session monitoring module 206 and the service provider application 208 (see FIG. 2). The processing system 306 may be implemented using software, hardware, or a combination of both.

The functionality of processing system 306 according to one configuration of an ad hoc mobile service provider 106 will now be presented. Those skilled in the art will readily appreciate that other configurations of the ad hoc mobile service provider 106 may include a processing system 306 that has the same or different functionality.

The processing system 306 in the ad hoc mobile service provider 106 may be configured to provide means for supporting a public service set, comprising the ad hoc mobile service provider 106 and one or more mobile clients 108, and a private service set, comprising the ad hoc mobile service provider 106 and one or more authenticated mobile clients 108. The processing system 306 further may be configured to provided means for authenticating a mobile client 108 with a server, where the mobile client 108 is associated with the public service set. The processing system 306 also may be configured to provide means for transferring an authenticated mobile client 108 from the public service set to the private service set.

The term “service set” will be used herein to refer to two or more mobile nodes associated with each other and configured for two-way data communication within the service set using a wireless access protocol. A service set may be public such that its identification and association parameters are publicly broadcast to unassociated mobile nodes. Alternatively, a service set may be private such that its identification and association parameters are not publicly broadcast. Additionally, a private service set may use one or more layers of encryption to secure data communication with the service set. Referring to FIG. 2, a pair of mobile clients 108 are depicted with wireless links to the WLAN network interface 204 of the ad hoc mobile service provider 106. Both of the mobile clients 108 may form a single service set with the ad hoc mobile service provider 106. In another configuration, each mobile client 108 may form a different service set with the ad hoc mobile service provider 106. It is to be understood that a service set may contain more than two mobile nodes and that the ad hoc mobile service provider 106 may support more than two service sets with one or more mobile clients 108 in each service set with the ad hoc mobile service provider.

The processing system in the ad hoc mobile service provider 106 may function to establish a wireless access point for one or more mobile clients 108 to access the Network 102 via WWAN 104. When the processing system decides to establish a wireless access point for one or more mobile clients 108, it sends a request to the server 110 for approval. The processing system requests authentication by the server 110 and approval from the server 110 to provide service to one or more mobile clients 108. The server 110 may authenticate the ad hoc mobile service provider 106 and then determine whether it will grant the ad hoc mobile service provider's request. As discussed earlier, the request may be denied if the number of ad hoc mobile service providers in the same geographic location is too great or if the WWAN operator has imposed certain constraints on the ad hoc mobile service provider 106.

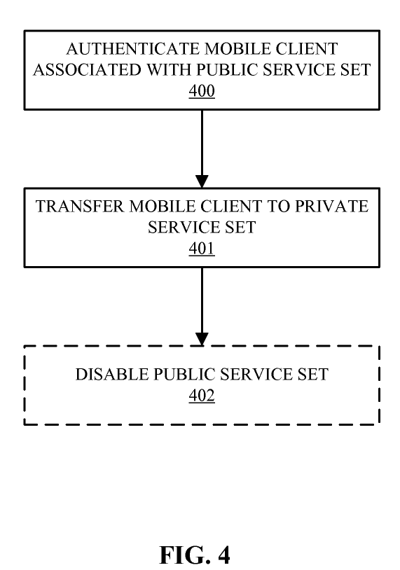

Once the ad hoc mobile service provider 106 is authenticated and approved to provide service to one or more mobile clients 108, the ad hoc mobile service provider 106 may advertise its availability to provide access to the WWAN 104 to mobile clients 108 within range of its WLAN transceiver 302. With reference to FIG. 4, which is a flowchart illustrating an exemplary method of managing the ad hoc mobile service provider 106, the operation and functionality of the ad hoc mobile service provider 106 providing service to one or more mobile clients 108 will now be described.

A TLS session may be used by the mobile client 108 to register with the server 110. Once registered, the mobile client 108 may search for available ad hoc mobile service providers 106. When the mobile client 108 detects the presence of one or more ad hoc mobile service providers 106, it may initiate a session using EAP-TTLS with an ad hoc mobile service provider 106 based on the level of access offered by the ad hoc mobile service provider 106. As described earlier, a link encryption key may be established between the mobile client 108 and the ad hoc mobile service provider 106 during the establishment of the session. An SSL VPN session may be established between the mobile client 108 and the server 110 so that all traffic between the two is encrypted. The transport layer ports may be kept in the open and not encrypted to provide visibility for the network address translation functionality at the ad hoc mobile service provider 106.

To advertise availability, the ad hoc mobile service provider 106 broadcasts a service set identifier (SSID) as well as other parameters for associating with a public service set associated with the ad hoc mobile service provider 106 using WLAN transceiver 302. Mobile clients 108 interested in the access offered by an ad hoc mobile service provider 106 may associate with the public service set identified by the broadcast SSID to access the ad hoc mobile service provider 106. The processing system in the ad hoc mobile service provider 106 may then authenticate the mobile clients 108 associated with the public service set with the server 110 in step 400, as described above. Once authenticated, the processing system of the ad hoc mobile service provider 106 may set up an interconnection bridge from the WLAN link to the mobile clients 108 over to the WWAN link to facilitate access to the Internet.

The processing system in the ad hoc mobile service provider 106 may provide a certain level of security by routing data between the mobile client 108 and the server 110 without being able to decipher the data. Similarly, the processing system may be configured to ensure data routed between the user interface and the WWAN cannot be deciphered by mobile clients. The processing system may use any suitable encryption technology to implement this functionality.

The processing system in the ad hoc mobile service provider 106 may also maintain a time period for a mobile client 108 to access a network. The time period may be agreed upon between the ad hoc mobile service provider 106 and the mobile client 108 during the initiation of the session. If the processing system determines that it is unable to provide the mobile client 108 with access to the network for the agreed upon time period, then it may notify both the server 110 and the mobile client 108 regarding its unavailability. This may occur due to energy constraints (e.g., a low battery), or other unforeseen events. The server 110 may then consider a handoff of the mobile client to another ad hoc mobile service provider 106, if there is such an ad hoc mobile service provider 106 in the vicinity of the mobile client 108. The processing system in the ad hoc mobile service provider 106 may support the handoff of the mobile client 108.

The processing system of the ad hoc mobile service provider 106 may be configured to transfer an authenticated client associated with the public service set to a private service set associated with the ad hoc mobile service provider 106 in step 401 shown in FIG. 4. Unlike the public service set, the identification and association parameters of the private service set are not openly broadcast to all mobile clients 108 in the vicinity of the WLAN transceiver 302. To transfer an authenticated mobile client 108 to the private service set, the processing system of the ad hoc mobile service provider 106 may package the private service set identifier and association parameters and securely transmit them directly to the authenticated mobile client 108 using WLAN transceiver 302. The processing system may secure the transmission by using a session key created for a secure link between the authenticated mobile client 108 and the ad hoc mobile service provider 106. The session key may be created by mobile client 108, the ad hoc mobile service provider 106 or the server 110 and exchanged with the mobile client 108 and the ad hoc mobile service provider 106 during the mobile client authentication process. Using the private SSID and association parameters, the authenticated mobile client 108 may disassociate from the public service set and associate with the private service set. Since the authenticated mobile client 108 has already been authenticated for the ad hoc mobile service provider 106, authentication with the server 110 may not be repeated.

In addition to being associated with a service set separate from the public service set, which is accessible by non-authenticated mobile clients 108, the private service set may use additional security mechanisms such as data link layer encryption algorithms for securing data communication within the private service set.

Authenticated mobile clients 108 may be transferred from the public service set to the private service set in response to one or more transfer events. Possible transfer events may include, but are not limited to, the authentication of the mobile client 108 with the server 110, the lapse of a set period of time since the mobile client 108 was authenticated with the server 110, and the disabling of the public service set, which will be described below. The set period of time may be configured by an administrator via the server 110 or the mobile subscriber may set the period of time directly at the ad hoc mobile service provider via the user interface.

The processing system in the ad hoc mobile service provider 106 may be configured to disable the public service set in step 402, shown in FIG. 4, in response to a capacity event. Capacity events may include, but are not limited to, an available data rate of access to the WWAN 104 dropping below a specified data rate and an authenticated number of mobile clients 108 associated with the ad hoc mobile service provider 106 exceeding a specified number.

The processing system in the ad hoc mobile service provider 106 may admit mobile clients 108 and provide them with a certain Quality of Service (QoS) guarantee, such as an expected average data rate during a session. Average throughputs provided to each mobile client 108 over a time window may be monitored. The ad hoc mobile service provider 106 may monitor the throughputs for all flows going through it to ensure that resource utilization by the mobile clients 108 is below a certain threshold, and that it is meeting the QoS requirement that it has agreed to provide to the mobile clients 108 during the establishment of the session. Should the available data rate of access to the WWAN 104 drop below a data rate that will prevent the ad hoc mobile service provider 106 from meeting the QoS requirements of the authenticated mobile clients 108, the processing system in the ad hoc mobile service provider 106 may disable the public service set in order to prevent additional mobile clients 108 from associating with the ad hoc mobile service provider 106 and requested access to the WWAN 104.

Rather than monitor the throughput for all of the authenticated mobile clients 108 granted access to the WWAN 104 through the ad hoc mobile service provider 106, the processing system in the ad hoc mobile service provider may be configured to disable the public service set once the number of authenticated mobile clients associated with the ad hoc mobile service provider 106 exceeds a specified number. The server 110 or the mobile subscriber may specify a maximum number of mobile clients 108 that may access the WWAN 104 through the ad hoc mobile service provider 106. The specified number may be based on limitations imposed by the wireless provider of the WWAN 104 that limit the number of individuals accessing the WWAN 104 using the mobile subscribers granted privileges. The specified number also may be based on a number of mobile clients 108 calculated to use the total available bandwidth of the ad hoc mobile service provider 106 based on observed or calculated average data rates of individual mobile clients 108 previously associated with the ad hoc mobile service provider 106.

The processing system in the ad hoc mobile service provider 106 may disable the public service set by disabling the broadcast of the public SSID and association parameters. The processing system in the ad hoc mobile service provider 106 also may be configured to deny any further associations with the public service set or stop authentication of any mobile clients 108 associated with the public service set.

In the event that one or more authenticated mobile clients 108 are associated with the public service set when a capacity event occurs, the processing system of the ad hoc mobile service provider 106 may be configured to transfer each of the authenticated mobile clients 108 to the private service set. Alternatively, the processing system may terminate the session with each of the authenticated mobile clients 108 when a capacity event occurs.

The processing system of the ad hoc mobile service provider 106 may be configured to dynamically allocate resources committed to the public service set and the private service set when each service set includes at least one associated mobile client 108. The processing system may alternate processing data traffic from each service set. The amount of time allocated to a particular service set by the processing system may be based on the number of mobile clients 108 associated with each service set. This allocation may be directly proportional to the numbers in each set or may be weighted to allocate more time to the mobile clients 108 associated with the private service set. In addition to time, the processing system may allocate other resources such as available hardware resources or priority processing resources between the two service sets.

The processing system in the ad hoc mobile service provider 106 may enable a mobile subscriber to manage mobile clients 108 generally, and the sessions specifically, through the user interface. Alternatively, the processing system may support a seamless operation mode with processing resources being dedicated to servicing mobile clients 108. In this way, the mobile client 108 is managed in a way that is transparent to the mobile subscriber. The seamless operation mode may be desired where the mobile subscriber does not want to be managing mobile clients 108, but would like to continue generating revenue by sharing bandwidth with mobile clients 108.

If the bandwidth needs of a mobile client 108 are greater than the capabilities of the available ad hoc mobile service provider 106, then the mobile client 108 may access multiple ad hoc mobile service providers 106 simultaneously. A mobile client 108 with multiple transceivers could potentially access multiple ad hoc mobile service providers 106 simultaneously using a different transceiver for each ad hoc mobile service provider 106. If the same wireless access protocol can be used to access multiple ad hoc mobile service providers 106, then different channels may be used. If the mobile client 108 has only one transceiver available, then it may distribute the time that it spends accessing each ad hoc mobile service provider 106.

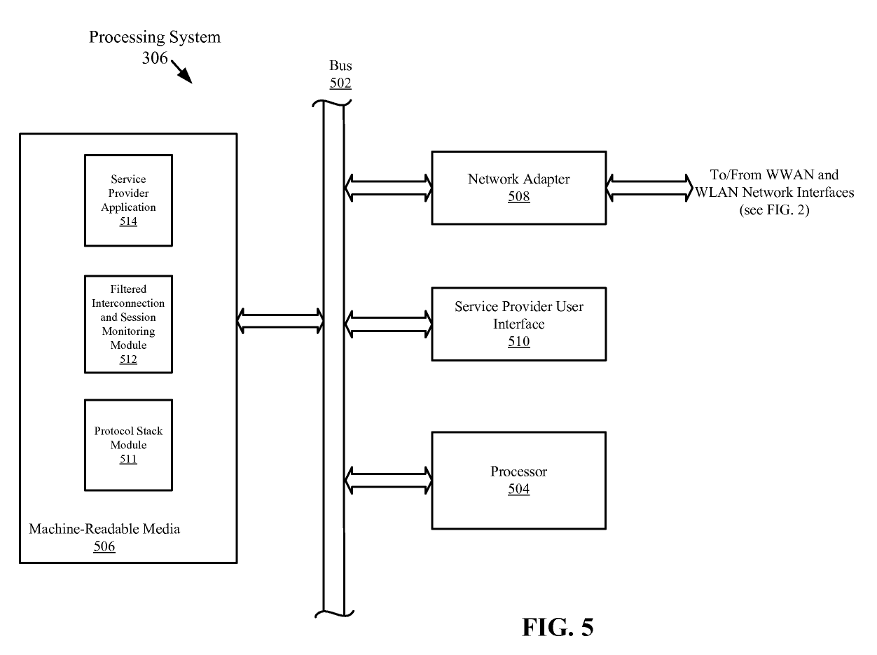

FIG. 5 is a simplified diagram illustrating an example of a hardware configuration for processing system 306 in ad-hoc service provider 106. In this example, processing system 306 may be implemented with a bus architecture represented generally by bus 502. The bus 502 may include any number of interconnecting buses and bridges depending on the specific application of processing system 306 and the overall design constraints. The bus 502 links together various circuits including a processor 504, machine-readable media 506, and a service provider user interface 510. The bus 502 may also link various other circuits such as timing sources, peripherals, voltage regulators, power management circuits, and the like, which are well known in the art, and therefore, will not be described any further. A network adapter 508 provides an interface between the WWAN and WLAN network interfaces 202, 204 (see FIG. 2) and the bus 502.

The processor 504 is responsible for managing the bus and general processing, including the execution of software stored on the machine-readable media 506. The processor 504 may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof.

In the hardware implementation illustrated in FIG. 5, the machine-readable media 506 is shown as part of processing system 306 separate from the processor 504. However, as those skilled in the art will readily appreciate, the machine-readable media 506, or any portion thereof, may be external to the processing system 504. By way of example, the machine-readable media 506 may include a transmission line, a carrier wave modulated by data, and/or a computer product separate from the ad-hoc service provider 106, all which may be accessed by the processor 504 through the network interface 508. Alternatively, or in addition to, the machine readable media 506, or any portion thereof, may be integrated into the processor 504, such as the case may be with cache and/or general register files.

Processing system 306 may be configured as a general-purpose processing system with one or more microprocessors providing the processor functionality and external memory providing at least a portion of the machine-readable media 506, all linked together with other supporting circuitry through an external bus architecture. Alternatively, processing system 306 may be implemented with an ASIC (Application Specific Integrated Circuit) with the processor 504, the network interface 508, the service provider user interface 510, supporting circuitry (not shown), and at least a portion of the machine-readable media 506 integrated into a single chip, or with one or more FPGAs (Field Programmable Gate Array), PLDs (Programmable Logic Device), controllers, state machines, gated logic, discrete hardware components, or any other suitable circuitry, or any combination of circuits that can perform the various functionality described throughout this disclosure. Those skilled in the art will recognize how best to implement the described functionality for processing system 306 depending on the particular application and the overall design constraints imposed on the overall system.

The machine-readable media 506 is shown with a number of software modules. The software modules include instructions that when executed by the processor 504 cause the processing system to perform various functions. Each software module may reside in a single storage device or distributed across multiple memory devices. By way of example, a software module may be loaded into RAM from a hard drive when a triggering event occurs. During execution of the software module, the processor 504 may load some of the instructions into cache to increase access speed. One or more cache lines may then be loaded into a general register file for execution by the processor 504. When referring to the functionality of a software module below, it will be understood that such functionality is implemented by the processor 504 when executing instructions from that software module.

A protocol stack module 511 may be used to implement the protocol architecture, or any portion thereof, for the ad-hoc service provider 106. In the implementation described thus far, the protocol stack module 511 is responsible for implementing several protocol layers running on top of the data link layers implemented by the WWAN and WLAN network interfaces 202, 204 (see FIG. 2). By way of example, the protocol stack module 511 may be used to implement the upper portion of the data link layer by providing flow control, acknowledgement, and error recovery. The protocol stack module 511 may also be used to implement the network layer by managing source to destination data packet transfer, as well as the transport layer by providing transparent transfer of data between end users. Although described as part of the processing system, the protocol stack module 511, or any portion thereof, may be implemented by the WWAN and WLAN network adapters 202, 204.

The machine-readable media 506 is also shown with a filtered interconnection and session monitoring module 512 and service provider application 514. These software modules, when executed by the processor 504, cause the processing system to carry out the process steps as shown and described with respect to FIGS. 1-4 in connection with the ad-hoc service provider 106.

The user interface 510 may include a keypad, display, speaker, microphone, joystick, and/or any other combination user interface devices that enable a mobile subscriber or user to access the WWAN or the Internet 102.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in information of their functionality. Whether such functionality is implemented as hardware or software depends upon the particular application and design constraints imposed on the overall system. Skilled artisans may implement the described functionality in varying ways for each particular application.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An ad hoc mobile service provider for a wireless network, the ad hoc mobile service provider comprising:
a processing system configured to:
support a public service set comprising the ad hoc mobile service provider and one or more mobile clients,
support a private service set comprising the ad hoc mobile service provider and one or more authenticated mobile clients,
authenticate a mobile client with a server, the mobile client being associated with the public service set, and
transfer an authenticated mobile client from the public service set to the private service set.

2. The ad hoc mobile service provider of claim 1, wherein the processing system is further configured to disable the public service set in response to a capacity event.

3. The ad hoc mobile service provider of claim 2, wherein the capacity event is at least one of an authenticated number of mobile clients exceeding a specified number and an available data rate of access to the wireless network dropping below a specified data rate.

4. The ad hoc mobile service provider of claim 2, wherein the processing system is configured to disable the public service set by disabling broadcasting of a service set identifier for the public service set.

5. The ad hoc mobile service provider of claim 1, wherein the processing system is further configured to dynamically allocate resources committed to the public service set and to the private service set.

6. The ad hoc mobile service provider of claim 1, wherein the processing system is further configured to transfer the authenticated mobile client from the public service set to the private service set in response to a transfer event.

7. The ad hoc mobile service provider of claim 7, wherein the transfer event is at least one of an expiration of a period of time, the authentication of the authenticated mobile client, and a disabling of the public service set.

8. The ad hoc mobile service provider of claim 1, wherein the private service set uses a data link layer encryption algorithm.

9. An ad hoc mobile service provider for a wireless network, the ad hoc mobile service provider comprising:
means for supporting a public service set comprising the ad hoc mobile service provider and one or more mobile clients;
means for supporting a private service set comprising the ad hoc mobile service provider and one or more authenticated mobile clients;
means for authenticating a mobile client with a server, the mobile client being associated with the public service set; and
means for transferring an authenticated mobile client from the public service set to the private service set.

10. The ad hoc mobile service provider of claim 9, wherein the means for supporting a public service set further disables the public service set in response to a capacity event.

11. The ad hoc mobile service provider of claim 10, wherein the capacity event is at least one of an authenticated number of mobile clients exceeding a specified number and an available data rate of access to the wireless network dropping below a specified data rate.

12. The ad hoc mobile service provider of claim 10, wherein the means for supporting a public service set further disables the public service set by disabling broadcasting of a service set identifier for the public service set.

13. The ad hoc mobile service provider of claim 9, further comprising means for dynamically allocating resources committed to the public service set and to the private service set.

14. The ad hoc mobile service provider of claim 9, wherein the means for transferring further transfers the authenticated mobile client from the public service set to the private service set in response to a transfer event.

15. The ad hoc mobile service provider of claim 14, wherein the transfer event is at least one of an expiration of a period of time, the authentication of the authenticated mobile client, and a disabling of the public service set.

16. The ad hoc mobile service provider of claim 9, wherein the private service set uses a data link layer encryption algorithm.

17. A method for managing an ad hoc mobile service provider for a wireless network, the method comprising the steps of:
authenticating a mobile client with a server, wherein the mobile client is associated with a public service set comprising the ad hoc mobile service provider and the mobile client; and
transferring the authenticated mobile client from the public service set to a private service set comprising the ad hoc mobile service provider and one or more authenticated mobile clients.

18. The method of claim 17, further comprising the step of disabling the public service set in response to a capacity event.

19. The method of claim 18, wherein the capacity event is at least one of an authenticated number of mobile clients exceeding a specified number and an available data rate of access to the wireless network dropping below a specified data rate.

20. The method of claim 18, wherein the disabling step comprises disabling the broadcasting of a service set identifier for the public service set.

21. The method of claim 17, further comprising the step of dynamically allocating resources committed to the public service set and to the private service set.

22. The method of claim 17, wherein the transferring step comprises transferring the authenticated mobile client from the public service set to the private service set in response to a transfer event.

23. The method of claim 22, wherein the transfer event is at least one of an expiration of a period of time, the authentication of the authenticated mobile client, and a disabling of the public service set.

24. The method of claim 17, wherein the private service set uses a data link layer encryption algorithm.

25. A machine-readable medium comprising instructions executable by a processing system in an ad hoc mobile service provider for a wireless network, the instructions comprising code for:
authenticating a mobile client with a server, wherein the mobile client is associated with a public service set comprising the ad hoc mobile service provider and the mobile client; and
transferring the authenticated mobile client from the public service set to a private service set comprising the ad hoc mobile service provider and one or more authenticated mobile clients.

26. The machine-readable medium of claim 25, the instructions further comprising code for disabling the public service set in response to a capacity event.

27. The machine-readable medium of claim 26, wherein the capacity event is at least one of an authenticated number of mobile clients exceeding a specified number and an available data rate of access to the wireless network dropping below a specified data rate.

28. The machine-readable medium of claim 26, the instructions further comprising code for disabling the broadcasting of a service set identifier for the public service set.

29. The machine-readable medium of claim 25, the instructions further comprising code for dynamically allocating resources committed to the public service set and to the private service set.

30. The machine-readable medium of claim 25, the instructions further comprising code for transferring the authenticated mobile client from the public service set to the private service set in response to a transfer event.

31. The machine-readable medium of claim 30, wherein the transfer event is at least one of an expiration of a period of time, the authentication of the authenticated mobile client, and a disabling of the public service set.

32. The machine-readable medium of claim 25, wherein the private service set uses a data link layer encryption algorithm.
